(19) United States
(12) Patent Application Publication
(10) Pub. No.: US 2008/0171306 A1
(43) Pub. Date: Jul. 17, 2008

(54) Translucent, isotropic endodontic post

(76) Inventors: Artie J. Goldberg, West Hartford, CT (US); Charles J. Burstone, Farmington, CT (US)

Correspondence Address: ALIX YALE & RISTAS LLP, 750 MAIN STREET, SUITE 1400, HARTFORD, CT, 06103, US

(21) Appl. No.: 12/009,281

(22) Filed: Jan. 17, 2008

Related U.S. Application Data
(60) Provisional application No. 60/880,861, filed on Jan. 17, 2007.

(51) Int. Cl. A61C 5/11; C08G 61/10

(52) U.S. Cl. 433/220; 528/396; 524/1

(57) ABSTRACT

An endodontic device includes a thermoplastic polymer having a polymer backbone having arylene or heteroarylene moieties joined together by covalent bonds between ring carbon atoms.

### CROSS-REFERENCE TO RELATED APPLICATIONS

This application claims the benefit under 35 U.S.C. § 119(e) of U.S. Provisional Patent Application Ser. No. 60/880,861 filed Jan. 17, 2007.

### Field

The present disclosure relates generally to polymer comprising endodontic devices.

### BACKGROUND

Inside the tooth, under the white enamel and a hard layer called the dentin, is a soft tissue called pulp. Pulp contains blood vessels, nerves, and connective tissue and creates the surrounding hard tissues of the tooth during development. Pulp tissue extends from the crown of the tooth to the tip of the roots where it connects to the tissues surrounding the root. Once mature, a tooth can survive without pulp tissue.

Endodontics is the branch of dentistry that deals with diseases and treatment of the tooth root, pulp and surrounding tissue. Endodontic treatment is necessary when the pulp tissue inside the root canal becomes inflamed or infected. If pulp inflammation or infection is left untreated, it can cause pain or lead to an abscess and loss of the tooth. A major benefit of endodontic therapy is the ability to retain the natural tooth even if the pulp tissue needs to be removed.

During endodontic treatment an opening is made in the tooth. The pulp tissue is removed from the tooth and the root canals are shaped. Teeth undergoing endodontic treatment have often experienced extensive decay (carious lesions), which along with the removal of tissues associated with the endodontic treatment often results in insufficient remaining tooth structure for conventional restorative procedures. In cases where insufficient tooth structure remains a metal post is secured inside the shaped canal of the tooth to provide for retention and lateral stability of the restoration. If a restoration such as a cap or crown is needed the metal post may comprise additional material called a “core”. The core mimics the shape of the tooth after traditional preparation of an otherwise intact tooth, allowing the dentist and dental laboratory to use their usual procedures and materials in fabricating the cap or crown. The core also provides support for the restoration.

Two general types of posts are known in the art: “active” or screw-in type systems and “passive” type systems. Active posts mechanically engage the walls of the root canal and tooth dentin such as by the use of threaded portions. Passive posts are bonded in endodontically treated teeth utilizing cements and the like.

The remaining space in the shaped root canal is filled with a biocompatible material, typically “gutta-percha.” After the tooth is cleaned and filled the restoration is placed on the tooth and anchored to the core to protect and restore the endodonticly treated tooth to full function.

There are several criteria that are desirable for endodontic devices such as posts. The material used to form the endodontic device must be non-toxic and resistant to the corrosive environment within a patient's mouth. The endodontic device should be available in, or formable to, desired shapes and dimensions. The inventors believe that the endodontic device should advantageously have a stiffness less than tooth dentin. Endodontic material should have isotropic properties for many applications.

Typically, metals such as stainless steel and titanium have been used to fashion endodontic devices such as posts. Metal posts are available in prefabricated sizes and shapes. Metal posts can also be cast in a mold to custom sizes and shapes if clinically indicated and if sufficient time is available. More recently fiber-reinforced composite (FRC) materials comprising a polymer matrix reinforced by fibers have been used to fashion endodontic devices such as posts.

Despite their long use conventional endodontic devices can be problematic. Tooth dentin has a stiffness (elastic. modulus) of about 18 GPa (gigaPascals). Conventionally used materials for endodontic devices have stiffnesses (in gigaPascals) of 200 (steel), 200 (ceramic), 80-140 (carbon fiber reinforced epoxy), 120 (titanium), and 25-35 (glass fiber reinforced dimethacrylate). Thus, the conventional endodontic materials are considerably stiffer than dentin. Fracture of the endodontically treated tooth can be due to wedging of the post during insertion or function or due to the difference in stiffness between the post and tooth dentin.

Oriented fiber-reinforced composite materials are anisotropic; that is, they have different mechanical properties in different axes or directions. Thus, manufacture of endodontic devices from fiber-reinforced composite materials is limited to certain orientations with respect to the reinforcing fibers so that the finished endodontic device can provide the desired properties in the correct axis. Control of fiber orientation during manufacture can also be problematic. Further, the torsional properties of an oriented fiber-reinforced composite material is lower than the axial or shear properties, giving the endodontic device made from the fiber-reinforced composite material less stability against twisting or rotational forces.

The metals and fiber-reinforced composites conventionally used for endodontic devices are very hard. Removal of an endodontic device made from these materials using common dental tools is difficult at best. Grinding or cutting of a fiber-reinforced composite device also exposes the oriented fibers.

Posts made from metal and fiber-reinforced composite materials cannot be easily formed in the clinical setting. In practice pre-fabricated posts are used in the as received shape and are not formed to the shape of the cleaned root canal. The only current method for developing a post that contours to the anatomy of the cleaned root canal is to make a custom cast metal post. A cast metal post is typically prepared in a dental laboratory remote from the clinical setting. Preparation of a cast metal post requires additional time to complete the endodontic procedure and increases costs.

Conventionally used materials for endodontic devices may be visually opaque. Placement of a conventional endodontic device in an anterior tooth may leave an objectionable shadow visible to others. Further, an opaque post can make curing of some light sensitive cements difficult.

It is generally believed that thermoplastic polymers such as polymethylmethacrylate (PM MA) or polycarbonate and even high strength polymers such as polyetheretherketone (PEEK) do not possess the properties desirable, or in some cases necessary, for use as an endodontic device. Table 1 lists the mechanical properties of some known high strength engineering polymers.

TABLE 1

| | | Flexure | | | |
|---|---|---|---|---|---|
| | | Strength, | Tensile | Tensile Strength, | |
| | Flexure | MPa | Modulus, | MPa | |
| Material | Modulus, GPa | Yield | GPa | Yield | Ultimate |
| Polybenzimidazole (PBI) | 6.6 | 221 | 5.8 | | 160 |
| Polyamide-imide (PAI) | | | 5.2 | | 185 |
| Polyphenylene sulfide | 3.8 | 96 | 3.8 | | 65 |
| (PPS) | | | | | |
| Polyetheretherketone | 4.1 | 170 | 3.5 | 97 | 120 |
| (PEEK) | | | | | |
| Polyether-imide (PEI) | 3.3 | 118 | 3.3 | | 103 |
| Polymethylmethacrylate | 2.3 | 91 | 2.5 | 51 | 53 |
| (PMMA) | | | | | |
| Polycarbonate (PC) | 2.8 | 88 | 2.3 | 62 | 70 |
| Acrylonitrile-butadiene- | 2.5 | 83 | 2.3 | | 50 |
| styrene (ABS) | | | | | |
| Polyamides (nylon) | 1.8 | 80 | 1.9 | 60 | 75 |
| Thermoplastic | 0.5 | | 1.2 | | 37 |
| Polyurethane | | | | | |

### Some Useful Definitions

The following terms will have the given definitions unless otherwise explicitly defined.

Anterior—Pertaining to the central, lateral and cuspid teeth.

Endodontic device—The term endodontic device includes a post or a post and core used for endodontic treatment. The term also includes pins used to enhance retention, for example in an anterior restoration.

Filler material—Particles, powder or other materials having approximately equal dimensions in all directions. Filler material is added to a polymer primarily to enhance polymer properties such as wear resistance, mechanical properties or color.

Non-Thermoplastic polymer—Any polymer which does not fall within the definition of a thermoplastic polymer.

Polymer—A long chain of covalently bonded, repeating, organic structural units. Generally includes, for example, homopolymers, copolymers, such as for example, block, graft, random and alternating copolymers, terpolymers, etc, and blends and modifications thereof. Furthermore, unless otherwise specifically limited, the term “polymer” includes all possible geometric configurations. These configurations include, for example, isotactic, syndiotactic and random symmetries.

Reinforcing agent—a filament, fiber, whisker, insert, etc. having a length much greater than its cross sectional dimensions. Reinforcing agents are primarily used to increase the mechanical properties of a polymer.

Stiffness—The ratio of a steady force acting on a deformable elastic material to the resulting displacement of that material.

Thermoplastic polymer—A polymer that is fusible, softening when exposed to heat and returning generally to its unsoftened state when cooled to room temperature. Thermoplastic materials include, for example, polyvinyl chlorides, some polyesters, polyamides, polyfluorocarbons, polyolefins, some polyurethanes, polystyrenes, polyvinyl alcohol, copolymers of ethylene and at least one vinyl monomer (e.g., poly (ethylene vinyl acetates), cellulose esters and acrylic resins.

Unreinforced—A material with substantially no reinforcing agent.

### SUMMARY

Briefly, one aspect of the disclosure is an endodontic device comprised of a thermoplastic, rigid backbone polymer.

Yet another aspect of the present disclosure is the provision of a translucent endodontic device providing an improved aesthetic appearance in use. The device is fabricated from a thermoplastic polymer having a refractive index of about 1.66 to about 1.70. The thermoplastic polymer ranges from transparent to translucent and may include fillers, additives or other materials to approximate the color of a patient's tooth. In one embodiment the translucent endodontic device comprises a rigid backbone polymer.

Still another aspect of the disclosure is a method of manufacturing an endodontic device comprising heating a thermoplastic polymer to a softened state and forming the softened thermoplastic polymer into an endodontic device.

In general, unless otherwise explicitly stated the disclosed materials may be alternately formulated to comprise, consist of, or consist essentially of, any appropriate components herein disclosed. The disclosed materials may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

A better understanding will be obtained from the following detailed description and the accompanying drawings as well as from the illustrative applications including the several components and the relation of one or more of such components with respect to each of the others as well as to the features, characteristics, compositions, properties and relation of elements described and exemplified herein.

### BRIEF DESCRIPTION OF THE DRAWINGS

FIG. 1 is a graph illustrating moment-deflection curves for endodontic posts formed from semi-rigid-rod polymer.

FIG. 2 is a side view illustrating one embodiment of a thermoplastic, rigid backbone polymer post.

FIG. 3 is a side view illustrating another embodiment of a thermoplastic, rigid backbone polymer post.

FIG. 4 is a side view illustrating another embodiment of a thermoplastic, rigid backbone polymer post.

FIG. 5 is a side view illustrating another embodiment of a thermoplastic, rigid backbone polymer post.

FIG. 6 is a side view illustrating the shadow formed when a conventional post is placed in a model tooth.

FIG. 7 is a side view illustrating a less visible thermoplastic, rigid backbone polymer post placed in a model tooth.

FIGS. 8a to 8c illustrate the formation of a shaped thermoplastic, rigid backbone polymer post by thermoforming.

FIG. 8d illustrates the shaped thermoplastic, rigid backbone polymer post of FIG. 8c placed in a cleaned root canal.

### DETAILED DESCRIPTION

In contrast to the prevailing knowledge in the art, it has now been discovered that certain thermoplastic polymers surprisingly do possess the combination of properties useful in an endodontic device. Since these thermoplastic polymers are useful without oriented reinforcing fibers the desirable mechanical properties are isotropic.

One class of polymers useful in forming an endodontic device is the rigid backbone polymers. As used herein, the term rigid backbone polymer encompasses any of a “rigid-rod polymer”, a “segmented rigid-rod polymer”, a “semi-rigid-rod polymer” or a combination thereof. Rigid backbone polymers have a backbone at least partially comprising arylene or heteroarylene moieties covalently bonded to each other. U.S. Pat. No. 5,886,130 (Trimmer et al.) and U.S. Pat. No. 6,087,467 (Marrocco, III et al.), the contents of which are incorporated by reference herein, provide further description of some rigid backbone polymers. PARMAX® 1000, PARMAX® 1200 and PARMAX® 1500, previously available from Mississippi Polymer Technologies, Inc. of Bay St. Louis, Miss., are representative of some rigid. backbone polymer materials found useful. PARMAX® 1200 is now believed to be PrimoSpire® PR-120 and PARMAX® 1500 is now believed to be PrimoSpire® PR-250. Both PrimoSpire materials are available from Solvay, Inc. of Alpharetta, Ga. Rigid backbone polymers have an advantageous balance of properties useful in endodontic applications, including high mechanical properties, isotropy, thermal formability and thermoplastic processing capability and sometimes translucency. In endodontic applications, the mechanical properties of unreinforced rigid backbone polymers are sufficient to deliver the necessary strength, which is only possible with certain other polymers when a second phase, high strength reinforcement, such as oriented fibers, are used. The absence of reinforcing fibers or particles in the rigid backbone polymer provides high ductility and ease of processing both for the clinician and the manufacturer, while maintaining a high degree of clarity, making for improved aesthetics. In addition, since the subject polymer is a thermoplastic there is for the first time the potential of using various thermal processing methods, such as injection molding, compression molding or extrusion to form endodontic devices with various shapes and geometries.

Rigid-rod polymers in one variation are comprised of phenylene monomer units joined together by carbon-carbon covalent bonds, wherein at least about 95% of the bonds are substantially parallel to each other. Preferably, the covalent bonds between monomer units are 1,4 or para linkages so that each monomer unit is paraphenylene. Each paraphenylene monomer unit can be represented by the following structure.

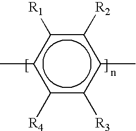

This molecular arrangement of paraphenylene groups, while able to rotate about its long axis, cannot bend or kink as is possible with most other engineering polymer backbones, imparting high mechanical properties.

A polymer consisting only of rigid-rod macromonomers would not be soluble, making synthesis very difficult and thermal processing impossible. Accordingly, each of R₁, R₂, R₃ and R₄ is independently chosen from H or an organic solubilizing group. The number and size of the organic solubilizing groups chosen being sufficient to give the monomers and polymers a significant degree of solubility in a common solvent system. As used herein, the term “soluble” means that a solution can be prepared containing greater than 0.5% by weight of the polymer and greater than about 0.5% of the monomer(s) being used to form the polymer. As used herein, the term “solubilizing groups” means functional groups which, when attached as side chains to the polymer in question, will render it soluble in an appropriate solvent system. PARMAX® 1000 (poly-1,4 (benzoylphenylene)), previously available from Mississippi Polymer Technologies, Inc., is one example of a rigid-rod polymer.

Segmented rigid-rod polymers are polymers that comprise both rigid-rod segments comprised of rigid-rod monomer units (defined above) and non-rigid-rod segments in the backbone of the polymer. The segmented rigid-rod polymer in one variation has the following structure:

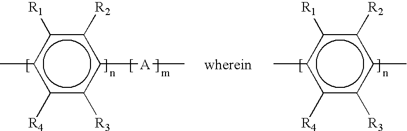

represents the rigid-rod monomer segment described above and the repeating [A] units are other than the rigid-rod segments. The average length of the rigid-rod segment (n) is about 8 monomer units, while the average length of the non rigid-rod segment (m) is at least 1. Each of R₁, R₂, R₃ and R₄ is independently chosen from H or an organic solubilizing group.

Semi-rigid-rod polymers in one variation comprise a backbone comprising (1,4) linked paraphenylene monomer units and non-parallel, phenylene monomer units. Preferably, the non-parallel phenylene monomer units comprise (1,3) or meta phenylene polymer units. By introducing non-parallel phenylene repeat units, specifically meta-phenylene repeat units, solubility and processability can be maintained with fewer solubilizing groups (R₁-R₄) than are required for rigid-rod polymers. These semi-rigid-rod polymers, with fewer parallel paraphenylene units in the backbone are at most semi-rigid and do not have the extremely high viscosity characteristics of rigid-rod polymers, yet still have mechanical properties superior to standard engineering thermoplastics. One example of a para and meta structure is a random co-polymer of benzoyl appended 1,4-phenylene and 1,3-phenylene, which is similar in structure to the commercial polymer PrimoSpire® PR-120 and PARMAX® 1200.

In some embodiments, the properties for rigid backbone polymers such as tensile strength and tensile modulus are dependent on the chemical structure of the polymer and processing conditions used to prepare the polymer. Alteration of the monomer components and monomer component ratios is believed to allow lower values for properties such as tensile strength and tensile modulus. For example, the monomer component ratios could be altered to achieve a rigid backbone polymer having a neat resin tensile strength of about 150 MPa or lower and a neat resin tensile modulus of about 4 GPa or lower.

All three classes of rigid backbone polymers use solubilizing side groups to some extent. It is well known that it is difficult a priori to select an appropriate solvent, thus various factors will determine the effectiveness of the selected solubilizing groups. Such factors include the nature of the backbone itself, the size of the solubilizing groups, the orientation of the individual monomer units, the distribution of the stabilizing groups along the backbone, and the match of the dielectric constants and dipole moments of the solubilizing groups and the solvent. Nevertheless, general strategies have been developed. For example, if the rigid-rod or segmented rigid-rod polymers are to be synthesized in polar solvents, the pendant solubilizing groups of the polymer and the monomer starting material will be a group that is soluble in polar solvents. Similarly, if the rigid-rod or segmented rigid-rod polymers are to be synthesized in non-polar solvents, the pendant solubilizing group on the rigid-rod polymer backbone and the monomer starting material will be a group that is soluble in non-polar solvents.

Solubilizing groups which can be used include, but are not limited to, alkyl, aryl, alkaryl, aralkyl, alkyl amide, aryl amide, alkyl thioether, aryl thioether, alkyl ketone, aryl ketone, alkoxy, aryloxy, benzoyl, cyano, fluorine, heteroaryl, phenoxybenzoyl, sulfone, ester, imide, imine, alcohol, amine, and aldehyde. These solubilizing groups may be unsubstituted or substituted as described below. Other organic groups providing solubility in particular solvents can also be used as solubilizing groups. In some embodiments adjacent solubilizing groups may be bridging.

Additional pendant solubilizing side groups include alkylester, arylester, alkylamide and arylamide acetyl, carbomethoxy, formyl, phenoxy, phenoxybenzoyl, and phenyl. Further solubilizing side groups may be chosen from —F, —CN, —CHO, —COR, —CR═NR′, —OR, —SR, —SO₂R, —OCOR, —CO₂R, —NRR′, —N═CRR′, —NRCOR′, —CONRR′, and R, where R and R′ are each selected independently from the group consisting of H, alkyl, substituted alkyl, aryl, substituted aryl, heteroaryl and substituted heteroaryl.

Unless otherwise specifically defined, alkyl refers to a linear, branched or cyclic alkyl group having from 1 to about 9 carbon atoms including, for example, methyl, ethyl, propyl, butyl, hexyl, octyl, isopropyl, isobutyl, tert-butyl, cyclopropyl, cyclohexyl, cyclooctyl, vinyl and allyl. A linear and branched alkyl group can be saturated or unsaturated and substituted or unsubstituted. A cyclic group is saturated and can be substituted or unsubstituted.

Unless otherwise specifically defined, aryl refers to an unsaturated ring structure, substituted or unsubstituted, that includes only carbon as ring atoms, including, for example, phenyl, naphthyl, biphenyl, 4-phenoxyphenyl and 4-fluorophenyl.

Unless otherwise specifically defined, heteroaryl refers to an unsaturated ring structure, substituted or unsubstituted, that has carbon atoms and one or more heteroatoms, including oxygen, nitrogen and/or sulfur, as ring atoms, for example, pyridine, furan, quinoline, and their derivatives.

Unless otherwise specifically defined, heterocyclic refers to a saturated ring structure, substituted or unsubstituted, that has carbon atoms and one or more heteroatoms, including oxygen, nitrogen and/or sulfur, as ring atoms, for example, piperidine, morpholine, piperazine, and their derivatives.

Unless otherwise specifically defined, “alcohol” refers to the general formula alkyl-OH or aryl-OH.

Unless otherwise specifically defined, “ketone” refers to the general formula —COR including, for example, acetyl, propionyl, t-butylcarbonyl, phenylcarbonyl (benzoyl), phenoxyphenylcarbonyl, 1-naphthylcarbonyl, and 2-fluorophenylcarbonyl.

Unless otherwise specifically defined, “amine” refers to the general formula —NRR′ including, for example, amino, dimethylamino, methylamino, methylphenylamino and phenylamino.

Unless otherwise specifically defined, “imine” refers to the general formula —N═CRR′ including, for example, dimethyl imino (R and R′ are methyl), methyl imino (R is H, R′ is methyl) and phenyl imino (R is H, R′ is phenyl) and the formula —CR═NR′ including, for example, phenyl-N-methylimino, methyl-N-methylimino and phenyl-N-phenylimino

Unless otherwise specifically defined, “amide” refers to the general formula —CONRR′ including, for example, N,N-dimethylaminocarbonyl, N-butylaminocarbonyl, N-phenylaminocarbonyl, N,N-diphenylaminocarbonyl and N-phenyl-N-methylaminocarbonyl and to the general formula —NRCOR′ including, for example, N-acetylamino, N-acetylmethylamino, N-benzoylamino and N-benzoylmethylamino.

Unless otherwise specifically defined, “ester” refers to the general formula —CO₂R including, for example, methoxycarbonyl, benzoyloxycarbonyl, phenoxycarbonyl, naphthyloxycarbonyl and ethylcarboxy and the formula —OCOR including, for example, phenylcarboxy, 4-fluorophenylcarboxy and 2-ethylphenylcarboxy.

Unless otherwise specifically defined, “thioether” refers to the general formula —SR including, for example, thiomethyl, thiobutyl and thiophenyl.

Unless otherwise specifically defined, “sulfonyl” refers to the general formula —SO₂R including, for example, methylsulfonyl, ethylsulfonyl, phenylsulfonyl and tolylsulfonyl.

Unless otherwise specifically defined, “alkoxy” refers to the general formula —O-alkyl including, for example, methoxy, ethoxy, 2-methoxyethoxy, t-butoxy. Unless otherwise specifically defined, “aryloxy” refers to the general formula —O-aryl including, for example, phenoxy, naphthoxy, phenylphenoxy, 4-methylphenoxy.

Unless otherwise specifically defined, R and R′ are each independently selected from hydrogen, alkyl, substituted alkyl, heteroalkyl, aryl, substituted aryl, heteroaryl and substituted heteroaryl. Useful substituent groups are those groups that do not deleteriously affect the desired properties of the compound. Substituent groups that do not deleteriously affect the desired properties of the compound include, for example, alkoxy, alkyl, halogen, —CN, —NCS, azido, amide, amine, hydroxy, sulfonamide and lower alcohol.

The rigid backbone polymers described above could be used in various “forms” in the subject endodontic device. In one embodiment the polymers might be used alone as neat resins. In this embodiment, variations of the rigid-rod, segmented rigid-rod or semi-rigid backbone and the solubilizing groups may be desirable to achieve preferred balances of properties.

In another embodiment, rigid backbone polymers can be mixed with other materials such as, for example, additives, filler materials, plasticizers and reinforcing agents. The resulting compounds have properties that can be tailored to the desired end use. It should be noted that filler materials are added to a polymer matrix predominately to improve wear, alter color or reduce friction of the resulting material. 30 Strength enhancement, while possible, is generally limited with filler material additions. Reinforcing agents such as glass fibers or carbon fibers are added primarily to improve strength properties of the resulting material, sometimes by two or three times the unreinforced strength. Either chopped or continuous reinforcing fibers can be used. The improvement in properties generally increases with the aspect ratio of the fibers. However, reinforcing fibers have several disadvantages, particularly for an endodontic application. Desirable isotropic properties are lost when using continuous reinforcing fibers. If manipulation of endodontic devices is necessary, such as bending of an endodontic post, fibers may shift from a uniform, homogeneous distribution, deteriorating the mechanical properties. In some variations an endodontic device consists essentially of a rigid backbone polymer and no more than 5% by weight of a reinforcing agent. As used herein, “an endodontic device consisting essentially of a rigid backbone polymer and no more than 5% by weight of a reinforcing agent” means that the endodontic device contains no more than 5% by weight of materials intended primarily to increase the mechanical properties of the polymer.

In a further embodiment, at least one rigid backbone polymer can be used as an effective, molecular reinforcing component in other engineering thermoplastics. For example, a polyphenylene polymer could be blended with other engineering thermoplastics, such as polycarbonate. Blending results in a physical mixing of two distinct polymer chains, for example a rigid-rod polymer chain and a non-rigid-rod polymer chain such as polycarbonate. Blending and polymer blends are intended to encompass all methods of achieving such physical mixing including, for example, coreaction of different monomers to form blended homopolymers. Such polymer blends can yield desirable properties with even small percentages of the polyphenylene polymer. In blends, the combination of the rigid backbone polymer with one or more flexible non-rigid backbone thermoplastic produces what is sometimes referred to as a molecular composite, wherein the rigid backbone molecules are somewhat analogous to fibers in a conventional fiber-reinforced composite. However, since molecular composites contain no fibers, they can be fabricated much more easily than fiber-reinforced composites and should be more amenable to forming in an endodontic clinical setting.

Molecular composites present problems due to the limited solubility and fusibility of the rigid-rod structures and phase separation (in blends) from the more flexible non-rigid backbone polymer. However, the literature teaches that use of the solubilizing groups and/or use of non-parallel meta-phenylene backbone structures described above alleviates the solubilizing and fusibility problems by somewhat disrupting the regular paraphenylene structure. To address the problem of phase separation, U.S. Pat. No. 5,869,592, the contents of which are incorporated by reference herein, describes the addition of reactive side groups to the phenylene macromonomers that chemically bind the rigid-rod structure to the flexible polymer and help insure maintenance of a uniform distribution of the rigid and flexible units, i.e. a uniform blend is maintained and phase separation is avoided. Such reactive side groups can be defined as compatibilizing side groups.

If many crosslinks are made between the rigid-rod polymer and the flexible polymer the resulting highly crosslinked structure will likely resemble a thermoset and should be processed accordingly. At the other extreme, if only a few reactive side groups per rigid-rod polymer chain are available to form crosslinks, a thermoplastic structure resembling a graft copolymer results. A non-limiting list of flexible polymers that can incorporate a rigid backbone polymer includes polyacetal, polyamide, polyimide, polyester and polycarbonate.

A molecular composite can also be formed by co-polymerization of a rigid-rod and non-rigid-rod polymer units. In co-polymerization the rigid-rod and non-rigid-rod polymer units are chemically bound. The rigid-rod molecules are somewhat analogous to fibers in fiber reinforced composites. However, since molecular composites contain no fibers, they can be fabricated much more easily than fiber-polymer composites and should be more amenable to forming in an endodontic clinical setting. The rigid-rod and non-rigid-rod monomer units can have various molecular architectures including, for example, a crosslinked polymer, a graft co-polymer or a semi-interpenetrating network.

In other embodiments, the rigid backbone polymer finds use as a post-polymerization additive. As a post-polymerization additive a rigid backbone polymer may be used in compounding, blending, alloying, or otherwise mixing with preformed polymers, preformed blends, alloys or mixtures of polymers. In these cases the solubilizing side groups and/or reactive side groups help make the rigid-rod polymer compatible with the non rigid-rod polymer to be reinforced. Such compounding, blending, alloying, etc. may be done by solution methods, melt processing, milling, calendering, grinding or other physical or mechanical methods, or by a combination of such methods.

Some properties of the above rigid backbone polymers are listed in Table 2. It should be noted that the properties listed in Table 2 are for neat polymers. As used herein, a neat polymer consists of a polymer resin with essentially no other materials. A neat polymer does not include, for example an additive, a filler, another polymer resin, a plasticizer or a reinforcing agent.

TABLE 2

| Property | rigid-rod polymer | semi-rigid-rod polymer |
|---|---|---|
| density (g/cm³) | 1.21 | 1.23 |
| refractive index | 1.71 | 1.66-1.70 |
| glass transition | 160 | 165 |
| temperature (° C.) | | |
| elastic deformation | 32 | 37 |
| hardness, Rockwell B | 89 | 80 |
| hardness, pencil | ≧9H | 7h |

Some mechanical properties of rigid backbone polymers are listed in Table 3. It should be noted that the properties listed in Table 3 are for neat polymers. An endodontic post formed from a rigid backbone polymer and without oriented reinforcing fibers would have a similar modulus to an endodontic post of PEEK reinforced with 30% oriented glass fibers, however the unreinforced rigid backbone polymer post would be isotropic, have better ductility and a yield strength 20% higher than the PEEK reinforced with 30% oriented glass fibers. A rigid backbone polymer endodontic device when combined with fillers and/or reinforcing agents can provide even greater mechanical properties.

TABLE 3

| | Flexure | Flexure | Tensile | Tensile |
|---|---|---|---|---|
| | Modulus¹, | Strength¹, | Modulus², | Strength², |
| Material | GPa | MPa | GPa | MPa |
| rigid-rod polymer | 9.7 | 310 | 10.3 | 207 |
| semi-rigid-rod polymer | 8.3 | 310 | 8.3 | 255 |
| PARMAX ® 1500 | 6.6 | 255 | — | — |

¹ASTM D790
²ASTM D638

As can be seen from Tables 2 and 3, the rigid backbone polymer materials have advantageous properties. In some variations an endodontic device can be prepared consisting essentially of a rigid backbone polymer. As used herein, “an endodontic device consisting essentially of a rigid backbone polymer” means that the endodontic device does not contain any material in the polymer matrix that would affect the desirable properties of the neat rigid backbone polymer.

Some rigid backbone polymers have isotropic strength related properties. No orientation of this type of polymer is necessary to achieve desired strength properties. Rigid backbone polymer isotropy is desirable as it allows manufacture of the endodontic device without orientation of the base material in any particular axis. Further, the manufactured endodontic devices have relatively constant properties in all directions easing use of the device. Naturally, other endodontic devices comprising rigid backbone polymers incorporating a reinforcing agent may exhibit anisotropic strength properties depending on the reinforcing agent if desired for a particular application.

An advantageous property of rigid backbone polymers is resistance to creep or minimal stress relaxation. Traditional polymers can exhibit high elastic deformation. However, loads under the yield strength cause permanent deformation over time making them less suitable for endodontic applications. An endodontic device comprising a rigid backbone polymer is resistant to such creep and will deform less over time compared to traditional polymers.

Another advantageous property of rigid backbone polymers is hardness. As can be seen from Table 2, rigid backbone polymers can have hardnesses of up to about 80 to about 89 on the Rockwell B scale. While these rigid backbone polymer hardness values are among the highest of any thermoplastic polymer material they are considerably softer than conventional dental implements and tools. Thus, conventional dental drills and bits can be used to cut or remove the endodontic device if needed.

Rigid backbone polymers can range from almost transparent to a translucent light yellow in color. As can be seen from Table 2, the refractive index of two exemplary rigid backbone polymers ranges from 1.66 to 1.71, closely matching the 1.66 refractive index of tooth enamel. In some embodiments, a rigid backbone polymer can also be blended with dyes, filler materials or other additives to impart a desired color to the endodontic device produced therefrom allowing, for example, a close approximation to tooth coloring. These properties lessen the possibility that an installed isotropic, thermoplastic endodontic device will create a visible shadow.

Rigid backbone polymers are thermoplastic and can be thermally formed by, for example, injection molding, compression molding or extrusion. Typical compression molding conditions are about 300° C. to about 350° C., with pressures of about 0.689 MPa (100 psi) using either polymer powder or pellets. Injection molding is also believed to be a viable thermal processing method for some rigid backbone polymers. Thermal forming facilitates manufacture of the endodontic device since complex endodontic device shapes can be injection or compression molded or extruded. Additionally, thermal forming of the rigid backbone polymer allows the core or part of the core to be fabricated as an integral part of the post. The thermoplastic nature of rigid backbone polymers further allows secondary thermal forming of endodontic device precursors or prefabricated endodontic devices, for example in a clinical setting by a clinician at the time of endodontic treatment.

The rigid backbone polymer materials can be machined and finished on standard equipment to form endodontic devices. Typically, rigid backbone polymer materials can be machined in a manner similar to aluminum with a resulting surface finish also similar to aluminum. Tools and techniques designed for plastics or laminates can also successfully be used with rigid backbone polymer materials. It should be noted that most metalworking fluids can be used with rigid backbone polymers including mineral oils that would dissolve or attack other polymers.

Advantageously, endodontic devices comprised of rigid backbone polymers can be bonded using heat or adhesives, for example a dimethacrylate based adhesive. Endodontic devices comprised of rigid backbone polymers are also believed to be bondable using commercially available dental adhesives such as TRANSBOND available from 3M-Unitek. Some form of mechanical retention, i.e. undercuts or roughening, designed into the endodontic devices would be advantageous to increase bond strength. The bond strength of endodontic devices comprised of rigid backbone polymer should be equivalent to, or better than, metal devices but may not be as strong as fiber-reinforced composite devices.

It should be understood that the following examples are included for purposes of illustration so that the disclosure may be more readily understood and are in no way intended to limit the scope of the disclosure unless otherwise specifically indicated.

### EXAMPLE 1

### Properties of Rigid Backbone Polymer Posts

Tensile testing was initially conducted on nominal 1 mm posts comprised of PARMAX® 1200 and PARMAX® 1500. As shown in the Table 4, for a single test sample, the tensile modulus values were comparable to the manufacturer's reported data but the strength values were lower.

TABLE 4A

| | | | | | | | Reported |
|---|---|---|---|---|---|---|---|
| | | | | Stress | Experimental | Reported | Tensile |
| Test | Diameter | Area | Peak | at Yield, | Modulus, | Modulus, | Strength |
| Sample | mm | mm² | Load N | MPa | GPa | GPa | MPa |
| 1¹ | 1.030 | 0.83 | 105.60 | 117.67 | 8.01 | 8.3 | 207³ |
| 2² | 1.260 | 1.25 | 174.72 | 139.93 | 5.33 | 6.6 | 159⁴ |

¹PARMAX ® 1200
²PARMAX ® 1500
³for PrimoSpire ® PR-120.
⁴for PrimoSpire ® PR-250.

Subsequent laboratory testing provided additional mechanical property data, including tensile and stress relaxation properties. The tensile values, shown below, are based on larger sample sizes.

TABLE 4B

| | | | | Yield | | | |
|---|---|---|---|---|---|---|---|
| | | | | Strength | Ultimate | Strain @ | Elong. @ |
| | | Dimension | Modulus | (2% offset, | Strength | Yield | Break |
| Mtl | N | mm | (Gpa) | MPa) | (MPa) | (%) | (mm) |
| 1 | 9 | 0.53 × 0.76 | 5.03 ± 0.40 | 138.44 ± 15.46 | 142.89 ± 10.86 | 3.45 ± 0.72 | 8.71 ± 5.74 |
| 2 | 6 | 1.15 ± 0.04 | 7.26 ± 0.27 | 176.44 ± 11.91 | 176.54 ± 11.92 | 3.72 ± 0.19 | 4.21 ± 0.85 |
| 2 | 3 | 1.18 ± 0.002 | 7.39 ± 0.23 | 178.13 ± 5.03 | 178.13 ± 5.03 | 3.5 ± 0.32 | 3.57 ± 0.35 |

1 PrimoSpire ® PR-250
2 PARAMAX
Values are mean ± standard deviation.
“n” indicates sample size.

### EXAMPLE 2

### Simulated Clinical Testing of Rigid Backbone Polymer Posts

Nominal 1 mm diameter poly(phenyleneybased (PARMAX® 1200) posts were tested under conditions simulating clinical loading. The testing followed a procedure previously described (Post & Core. State-of-Art, CRA Newsletter 22(11) 1998. See also www.cranews.com/additional study/1998/98-11/posts/postmeth.htm. Posts—A shift away from metal?, CRA Newsletter 28(5) 2004. See also http://www.cranews.org/additional_study/2004/04-05/index. htm). The contents of each of these references is incorporated herein by reference.

Generally following the disclosed procedures, posts were embedded into an acetal resin rod and cemented in place with epoxy, simulating cementation of a post into a tooth that had received endodontic root canal therapy. The posts were cut so that they extended 3 mm beyond the supporting rod. The post and rod assemblies were tilted 1.35° and load was applied until failure using a universal testing machine (858 Mini Bionix II, MTS Systems). The angulated load'simulates the combined horizontal and vertical loads on posts due to the contour of occluding cusps.

As shown in Table 5 the strength of the PARMAX® 1200 post, 536 MPa, was about one-half of the values for conventional reinforced composite posts and about one-quarter of the value for conventional metal posts currently on the market. The rigidity values show that once corrected for diameter, the rigidity of the PARMAX® 1200 post was comparable to a typical commercial fiber-reinforced composite post. In this test method, we define rigidity as the change in load with each increment of deflection of the tip of the post, with units of N/mm. The diameter of the fiber-reinforced composite (D.T. Light) post was 1.5 mm, compared to the 1.0 mm for the PARMAX® post. Rigidity was corrected by multiplying the PARMAX® 1200 values by (1.5/1.0)⁴=5.06; 41.2×5.06=208.5.

TABLE 5

| Post/ | | Strength, | Rigidity, N/mm | |
|---|---|---|---|---|
| Manufacturer | Type | MPa | Uncorrected | Corrected |
| Poly(phenylene)- | Polymer | 536 | 41.2 | 208.5 |
| based | | | | |
| PARMAX ® 1200 | | | | |
| Snowpost ™/ | Glass FRC | 947 | | |
| Abrasive | | | | |
| Technology | | | | |
| GF Carbon Fiber | Carbon | 1016 | | |
| Post ™/J. Morita | FRC | | | |
| D.T. Light ™/ | Quartz FRC | 1163 | 200 | 200 |
| Bisco | | | | |
| Parapost XP ™ | Titanium | 2249 | | |
| Titanium/Coltene/ | | | | |
| Whaledent | | | | |
| Parapost XP | Stainless | 2259 | | |
| Coltene/Whaledent | Steel | | | |

### EXAMPLE 3

### Flexure Testing of Rigid Backbone Polymer Posts

A free-end cantilever test was used to evaluate flexural properties. The testing generally followed a procedure previously described in A. J. Goldberg, C. J. Burstone and H. A. Koenig, “Plastic Deformation of Orthodontic Wires”, J. Dent. Res., 62(9): 1016-1020, 1983.

The material tested was a random copolymer of benzoyl appended 1,4-phenylene (15 mol % of the repeat units) and 1,3-phenylene (85 mol % of the repeat units) (previously available as PARMAX® 1200).

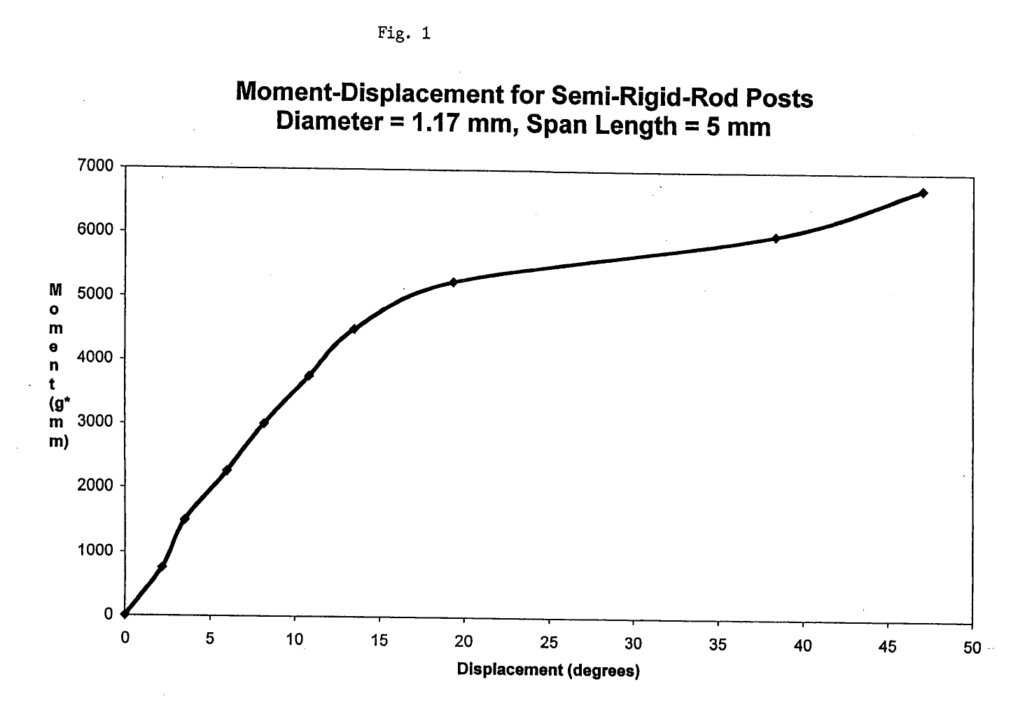

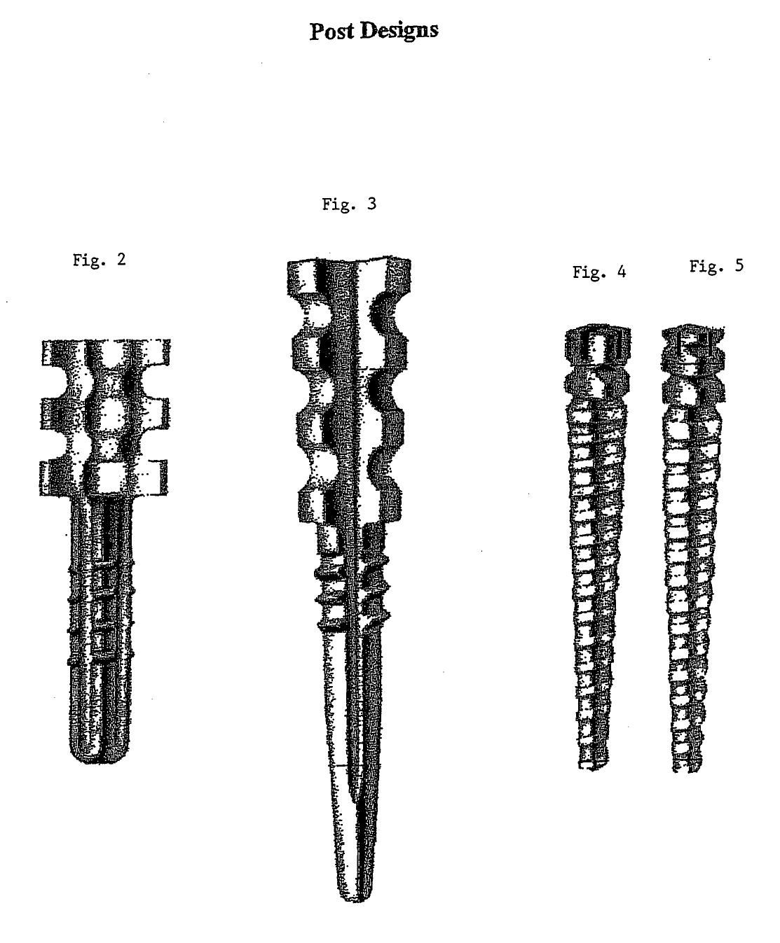

One end of a nominal 1 mm diameter endodontic post of the PARMAX® 1200 material was clamped to a torque watch (Waters, Inc.) while the free-end rested against a stop. The span length was 5 mm. The torque watch was manually rotated while the moment and angular deflection was measured. The mean moment-displacement curves for three posts is shown in FIG. 1.

### EXAMPLE 4

### Water Immersion and Flexure Testing of Rigid Backbone Polymer Posts

A free-end cantilever test was used to evaluate flexural properties before and after water immersion. Materials tested were poly-1,4-(benzoylphenylene) (previously available as PARMAX® 1000) and a random copolymer of benzoyl appended 1,4-phenylene (15 mol % of the repeat units) and 1,3-phenylene (85 mol % of the repeat units) (previously available as PARMAX® 1200). Polycarbonate (Tuffak™ available from Atohaas) was used as a control.

Two samples of each material were prepared with dimensions of 0.53 mm×0.64 mm×50.0 mm (width×thickness×length). Samples were conditioned in an oven for 24 hours at 50° C. and cooled in a desiccator. Following conditioning, one sample of each material was placed in a capped vial filled with deionized water. The vials were placed in a water bath maintained at 37° C. The second 50 mm long sample of each material was maintained in a desiccator. Samples were removed from the desiccator at 5 days and from the water bath (and towel dried) at 5 days, 30 days and 365 days and cut to lengths of 15 mm to accommodate a test span length of 5 mm. A free-end cantilever test was used to measure flexural rigidity, moment at yield and displacement at yield. These results are listed in Table 6.

TABLE 6

| PARMAX ® | PARMAX ® | |
|---|---|---|
| 1000 | 1200 | Polycarbonate |

Flexural Rigidity (g-mm/degree)

| | | | |
|---|---|---|---|
| Before Immersion | 41 | 36 | 13 |
| 5 days | 42 | 38 | 16 |
| 30 days | 51 | 53 | 22 |
| 365 days | 62 | 43 | 18 |

Moment at Yield (g-mm)

| | | | |
|---|---|---|---|
| Before Immersion | 950 | 933 | 300 |
| 5 days | 883 | 858 | 325 |
| 30 days | 708 | 650 | 279 |
| 365 days | 942 | 875 | 325 |

Displacement at Yield (degrees)

| | | | |
|---|---|---|---|
| Before Immersion | 28 | 32 | 33 |
| 5 days | 28 | 28 | 28 |
| 30 days | 14 | 14 | 13 |
| 365 days | 17 | 23 | 28 |

After 365 days of water immersion the PARMAX® 1200 sample showed little change in flexural rigidity or moment at yield but did exhibit a possible decrease in displacement at yield. After 365 days of water immersion the PARMAX® 1000 sample showed no change in moment at yield but did exhibit a possible increase in flexural rigidity and decrease in displacement at yield. The inventors believe that the changes could be due to experimental error and even if real that the changes are clinically insignificant. As can be seen from the results of Table 6, the rigid backbone samples have advantageous mechanical properties, both initially and after extended water immersion, when compared to samples made of conventional polymer materials.

### EXAMPLE 5

### Thermal Forming of Rigid Backbone Polymer Samples

Wires were thermally formed by hand to form selective curves and bends. The wires were a 1.07 mm diameter extrusion of a random copolymer of benzoyl appended 1,4-phenylene (15 mol % of the repeat units) and 1,3-phenylene (85 mol % of the repeat units) (previously available as PARMAX® 1200). The necessary conditions for forming the wires were determined by heating the samples to various combinations of temperatures and times in a laboratory oven. Samples 70 mm in length were heated at temperatures between 180° C. and 200° C. for 5 to 20 minutes. Samples heated to 195° C. for at least 15 minutes, or advantageously at 200° C. for 10 minutes or more, were sufficiently softened to be readily formed into desired configurations. The forming had to be done quickly before the samples cooled to their rigid state.

### EXAMPLE 6

### Thermal Forming of Rigid Backbone Polymer Posts

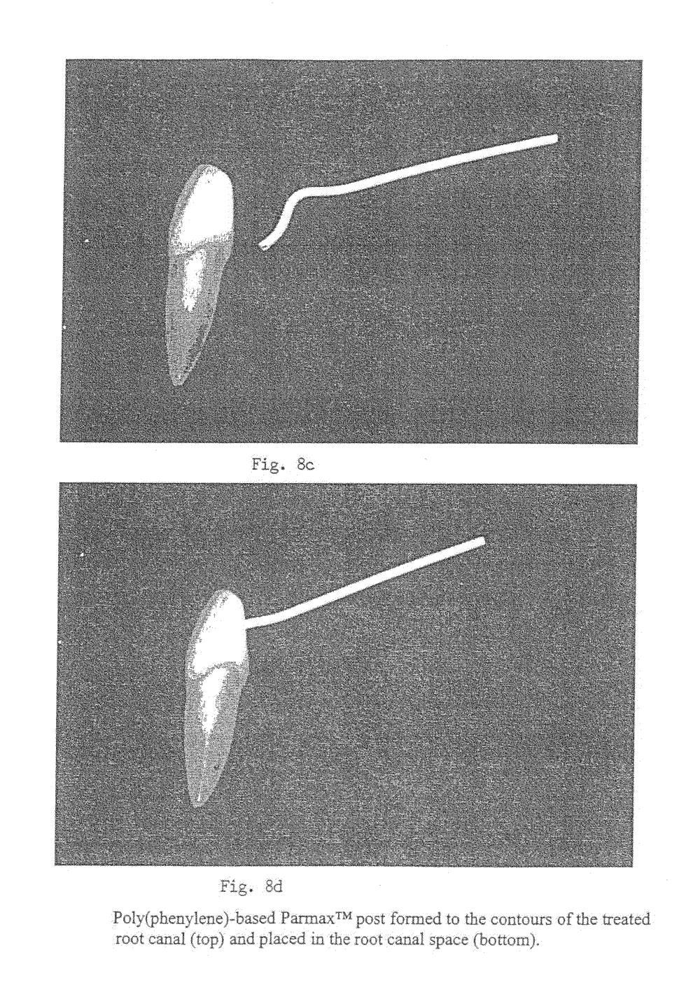

FIG. 8b illustrates use of a heat gun to warm a poly(phenylene)-based PARMAX® 1200 post to a softened state. After heating the post is formed as shown in FIG. 8c . FIG. 8d shows the formed post of FIG. 8c fitting within the contours of a cleaned and shaped root canal.

### EXAMPLE 7

### Evaluating the Effect of Time and Temperature on Rigid Backbone Polymer Flexure Properties

Flexure tests were conducted on 1.17 mm diameter rigid backbone polymer wires to determine if the various time and temperature combinations used in clinical forming affected mechanical properties of the formed device. 50 mm long by 1.17 mm diameter wires of a random copolymer of benzoyl appended 1,4-phenylene (15 mol % of the repeat units) and 1,3-phenylene (85 mol % of the repeat units) (previously available as PARMAX® 1200) were heated to 200° C. for periods of 10 to 80 minutes and between 185° C. and 210° C. for 15 minute periods. Each sample was allowed to bench cool and was cut into three 15 mm long samples. The samples were tested as 5 mm cantilevers recording angular deflection and torque. As shown in Table 7 and Table 8 there were no significant changes in flexure properties.

TABLE 7
constant temperature (200° C.) for various times

| | | Displacement | Moment |
|---|---|---|---|
| Time | Flexure rigidity | at Yield | at Yield |
| (minutes) | (g * mm/degrees) | (degrees) | (g * mm) |
| control | 383 | 8.2 | 3000 |
| 10 | 363 | 8.5 | 3000 |
| 20 | 351 | 8.7 | 3000 |
| 30 | 343 | 8.8 | 3000 |
| 40 | 356 | 8.5 | 3000 |
| 50 | 357 | 11.3 | 3750 |
| 60 | 374 | 8.3 | 3000 |
| 70 | 368 | 8.3 | 3000 |
| 80 | 348 | 8.8 | 3000 |

TABLE 8
constant time (15 minutes) for various temperatures

| | | Displacement | Moment |
|---|---|---|---|
| Temperature | Flexure rigidity | at Yield | at Yield |
| (° C.) | (g * mm/degrees) | (degrees) | (g * mm) |
| control | 396 | 8.2 | 3000 |
| 185 | 352 | 8.2 | 3000 |
| 190 | 383 | 8.2 | 3000 |
| 195 | 365 | 8.5 | 3000 |
| 200 | 351 | 8.7 | 3000 |
| 205 | 390 | 8.0 | 3000 |
| 210 | 396 | 8.0 | 3000 |

### EXAMPLE 10

### Esthetic Properties of Rigid Backbone Polymer Posts

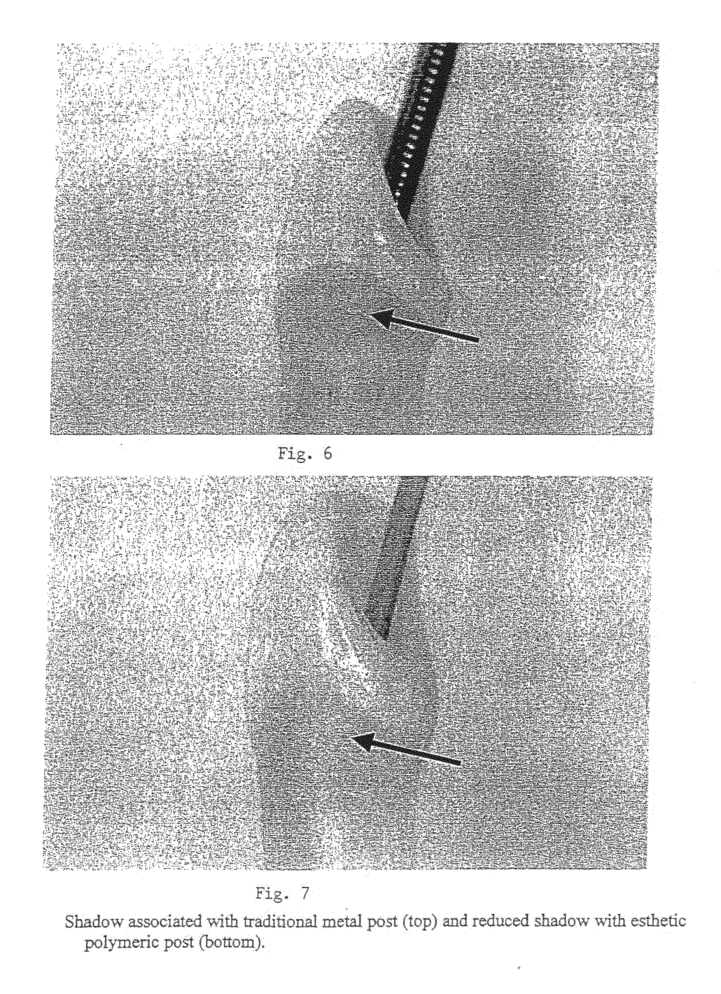

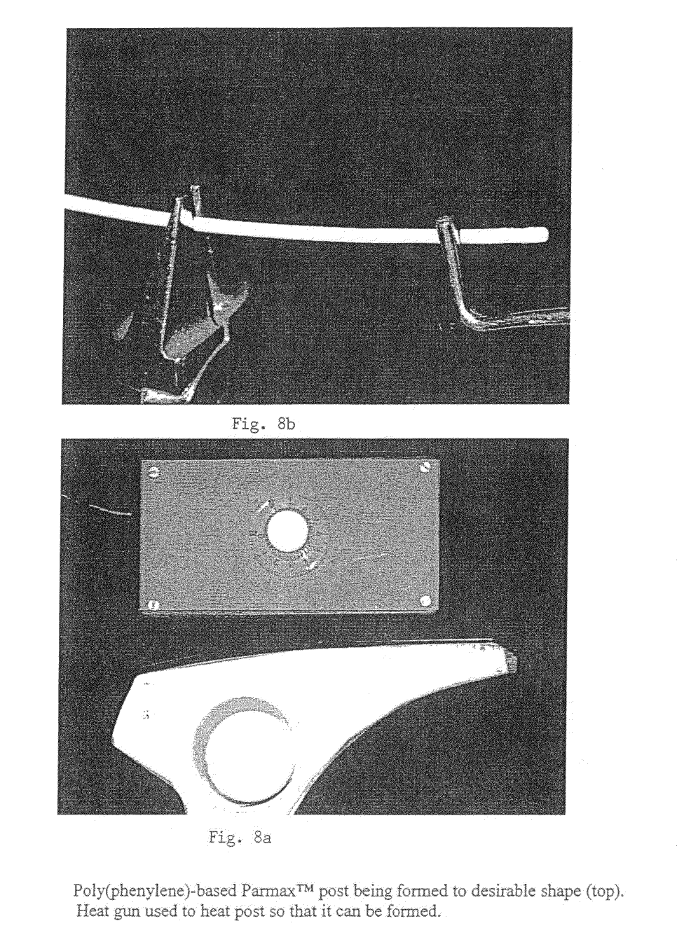

A conventional metal post (FIG. 6) and a rigid backbone polymer post (FIG. 7) were positioned in a model tooth. As shown in FIGS. 6 and 7 the rigid backbone polymer post exhibits less visible shadow than the conventional metal post.

### EXAMPLE 11

### Extruding Clinically Relevant Shapes

Long rods with small, clinically relevant rectangular and round cross sections have been manufactured. The rods were cut to typical dimensions for endodontic posts. This demonstrates the ability to form the necessary, clinically relevant cross-sectional profiles. The cross-sectional sizes formed were 0.019 inch (0.483 mm) round, 0.021×0.030 inch (0.533×0.762 mm) rectangular and 0.036 inch (0.914 mm) round. The approximately 0.9 mm round cross section is representative of an endodontic post diameter. Rectangular shapes are not typically used in endodontic posts, but demonstrated the ability to make non-circular cross sections.

### EXAMPLE 12

### Stress Relaxation

Under a load all polymers will relax, i.e. if maintained at constant deformation the stress within the sample will decrease with time.

Eight samples were loaded in tension to 20-63.5% of their Yield Strain. The initial strain was maintained and stress was measured versus time, generally until there was less than a 1% decrease in stress per hour, i.e. there was essentially no further stress relaxation. At that time the Final Stress was recorded. The Percent of Stress Maintained was calculated by dividing Final Stress by Initial Stress.

While there was the expected stress relaxation, it ended within 100 hours. All samples maintained at least 54% of their initial stress and values ranged up to 93.5%. However, in the endodontic application the load is not constant and any relaxation would likely recover, so the post would effectively maintain its full strength.

TABLE 9

| | | | Initial | Time | Final | |
|---|---|---|---|---|---|---|
| | | % | Stress | Stress | Stress | % of Stress |
| Material | Grade | of Yield Strain | (MPa) | was held | (MPa) | Maintained |
| Parmax | 1200 | 63.5 | 144.9 | 191 sec | 135.5 | 93.5 |
| Parmax | 1200 | 63.5 | 147.3 | 45 min | 117.9 | 80.0 |
| Parmax | 1200 | 80 | 161.0 | 54 hr | 87.2 | 54.2 |
| Parmax | 1200 | 80 | 150.9 | 103.2 hr | 81.6 | 54.0 |
| Primospire | 250 | 20 | 51.0 | 48 hr | 41.9 | 82.2 |
| Primospire | 250 | 40 | 62.1 | 22.5 hr | 52.5 | 84.5 |
| Primospire | 250 | 60 | 101.6 | 91.7 hr | 66.6 | 65.6 |
| Primospire | 250 | 80 | 125.4 | 69.9 hr | 75.7 | 60.0 |

### EXAMPLE 13

### Pigmenting for Aesthetics

Solvay has demonstrated that Primospire® can be pigmented to obtain a tooth-colored post if that becomes desirable. At our direction Solvay pigmented Primospire® to approach the common shade “A3” on the Vita® Dental Shade Guide. While we saw the sample and matched it the shade guide, we were not allowed to keep the sample.

### EXAMPLE 14

### Forming

One of the advantages of the esthetic self-reinforced (polyphenylene) post is its ease of formability to optimally meet the shape specifications of a patient's tooth. The post has two components 1) a radicular part inserted in the root canal and 2) a coronal part for the retention of a crown or a restoration.

Forming of the post can be primary or secondary. In primarily forming a customized shape can be formed using compression or injection molding that is unique for the patient copying the detailed shape of the root canal and the coronal retention configuration.

Prefabricated posts can also be modified to better contour to the needs of a specific tooth. This is called secondary forming using heat; the radicular portion can be narrowed, widened, or reshaped coronal-apically. The coronal portion by heat can be better shaped to retain a crown and to be better optimized for the shape of the coronal dimensions of specific teeth. In addition, the angle between the coronal and redicular parts of the post can be altered to optimize stresses and increase ease of insertion of a restoration. The ability to use prefabricated posts that can be individualized for the patient is not possible with FRC post applications and metal posts. Since most posts currently used are prefabricated, this secondary forming is an important advantage of the invention.

While preferred embodiments have been set forth for purposes of illustration, the foregoing description should not be deemed a limitation. Accordingly, various modifications, adaptations and alternatives may occur to one skilled in the art without departing from the spirit and scope of the present disclosure.

What is claimed is:

1. An endodontic device comprising a thermoplastic polymer having a polymer backbone comprising arylene or heteroarylene moieties joined together by covalent bonds between ring carbon atoms.

2. The endodontic device of claim 1, wherein the thermoplastic polymer is used in a neat form.

3. The endodontic device of claim 1, further comprising a reinforcing agent.

4. The endodontic device of claim 1, further comprising randomly oriented reinforcing fibers.

5. The endodontic device of claim 1, further comprising oriented reinforcing fibers.

6. The endodontic device of claim 1, further comprising filler.

7. The endodontic device of claim 1, further comprising a non-rigid backbone polymer.

8. The endodontic device of claim 1, selected from a post, a post and core or a pin.

9. The endodontic device of claim 1, comprising at least one of a compatibilizing side group or a solubilizing side group, wherein the side group reacts with a non-rigid backbone polymer and thereby reduces phase separation.

10. The endodontic device of claim 1, wherein the thermoplastic polymer has an unreinforced tensile strength of at least about 150 MPa and an unreinforced tensile modulus of at least about 4 GPa.

11. The endodontic device of claim 1, wherein the thermoplastic polymer has an unreinforced tensile strength of at least about 200 MPa and an unreinforced tensile modulus of at least about 8 GPa.

12. The endodontic device of claim 1, having a refractive index of about 1.66 to about 1.70.

13. The endodontic device of claim 1, having a maximum hardness of about 90 Rockwell B.

14. The endodontic device of claim 1, consisting essentially of the thermoplastic polymer.

15. The endodontic device of claim 1, wherein the thermoplastic polymer is in the form of a coating over at least part of a core.

16. The endodontic device of claim 1, wherein the polymer backbone comprises arylene or heteroarylene moieties joined together by 1,4 covalent bonds between adjoining ring carbon atoms.

17. The endodontic device of claim 1, wherein the polymer backbone comprises arylene or heteroarylene moieties joined together by covalent bonds between adjoining ring carbon atoms, wherein at least about 95% of the covalent bonds are substantially parallel to each other.

18. The endodontic device of claim 1, wherein the polymer backbone comprises the following structure:

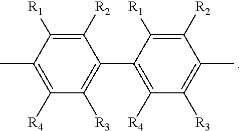

19. The endodontic device of claim 1, wherein the polymer backbone comprises the following structure: 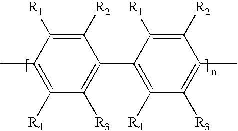
and n is an integer from 2 to about 8.

20. The endodontic device of claim 1, wherein the polymer backbone comprises the following structure: 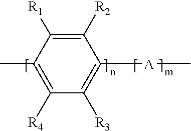
and A is a non-rigid rod segment, n is an integer from 2 to about 8 and M is an integer of at least 1.

21. The endodontic device of claim 1, comprising at least one of a compatibilizing side group or a solubilizing side group

22. A method of treating a tooth, comprising:
providing a thermoplastic polymer having a polymer backbone comprising arylene or heteroarylene moieties joined together by covalent bonds between adjoining ring carbon atoms;
heating the thermoplastic polymer to a softened state;
forming an endodontic device from the thermoplastic polymer while in the softened state;
providing a patient having a tooth in need of treatment;
making an opening in the tooth;
cleaning a root canal of the tooth; and
securing at least part of the formed endodontic device within the cleaned root canal.

23. The method of claim 22 wherein the step of forming is performed in the same clinical location as the step of cleaning.

24. A method of treating a tooth, comprising:
providing a patient having a tooth in need of treatment;
making an opening in the tooth;
cleaning a root canal of the tooth;
providing a thermoplastic polymer having a polymer backbone comprising arylene or heteroarylene moieties joined together by covalent bonds between adjoining ring carbon atoms;,
heating the thermoplastic polymer to a softened state;
forming an endodontic device from the thermoplastic polymer while in the softened state;
securing at least part of the formed endodontic device within the cleaned root canal.
